(19) United States
(12) Patent Application Publication
(10) Pub. No.: US 2019/0017909 A1
(43) Pub. Date: Jan. 17, 2019

(54) MITOCHONDRIA EXTRACTION APPARATUS

(71) Applicants: National Chung Hsing University, Taichung City (TW); Changhua Christian Medical Foundation Changhua Christian Hospital, Changhua City (TW)

(72) Inventors: Gou-Jen WANG, Taichung City (TW); Ching-Wen LI, Taichung City (TW); SUNG-TZU CHEN, Tainan City (TW); Chin-San LIU, Changhua City (TW); Jui-Chih CHANG, Changhua City (TW)

(21) Appl. No.: 16/033,545

(22) Filed: Jul. 12, 2018

(30) Foreign Application Priority Data
Jul. 14, 2017 (TW) 106123558

(51) Int. Cl. G01N 1/40; B01L 3/00; B01D 61/18; B01D 63/06

(52) U.S. Cl. CPC G01N 1/4077; B01L 3/5021; B01D 63/16; B01D 63/06; G01N 2001/4088; B01D 61/18

(57) ABSTRACT

A mitochondria extraction apparatus provided in the present invention includes a container used for holding a mixture fluid and a diafiltration assembly disposed in the container and used for isolating mitochondria. A basement of the mitochondria extraction apparatus is disposed in the container. During a circular motion of the mitochondria extraction apparatus, a centrifugal force in the mitochondria extraction apparatus acts on the mixture fluid in a hole-shaped microfluidic channel included in the diafiltration assembly, so as to provide a pushing force for the mixture fluid, enabling the mixture fluid to rapidly flow in the microfluidic channel for diafiltration.

### BACKGROUND OF THE INVENTION

### 1. Field of the Invention

The present invention relates to the technical field of medical engineering, and in particular, to a mitochondria extraction apparatus.

### 2. Description of the Related Art

Mitochondria are powerhouses of human cells and provide energy for cells. Mitochondrial diseases are caused by dysfunctional mitochondria. So far more than fifty related diseases have been found in Taiwan. Clinically, patients may suffer from abnormalities in organs such as brains, muscles, and hearts.

Therefore, it is urgent to develop treatments for mitochondrial diseases in the medical field. In mitochondrial replacement treatment, damaged mitochondria of a patient are replaced with healthy mitochondria to promote the proliferation of healthy mitochondria in the body of the patient, and at the same time the oxidative stress in cells is reduced to slow down the disease process. Therefore, a large quantity of intact mitochondria having desirable structure and activity are needed.

Conventional mitochondrial extraction using physical or chemical methods involves high-speed centrifugation, repeated freezing and thawing or reagent extraction. As a result, a small quantity of mitochondria with impaired structures and functions are obtained. Therefore, the technical content is still underdeveloped.

### SUMMARY OF THE INVENTION

Therefore, the main objective of the present invention is to provide a mitochondria extraction apparatus. A mitochondria-containing mixture fluid may be filled in the mitochondria extraction apparatus, and the mitochondria extraction apparatus makes a circular mot ion about a moving axis. The mitochondria-containing mixture fluid flows through the mitochondria extraction apparatus at an increased speed under a centrifugal force, to obtain a large quantity of mitochondria with desirable quality for the application to treatment of mitochondrial diseases.

In view of this, to achieve the foregoing objective, a mitochondria extraction apparatus provided in the present invention includes a container used for holding a mixture fluid and a diafiltration assembly disposed in the container and used for isolating mitochondria. During a circular motion of the mitochondria extraction apparatus, a centrifugal force in the mitochondria extraction apparatus acts on the mixture fluid in a hole-shaped microfluidic channel included in the diafiltration assembly, so as to provide a pushing force for the mixture fluid, enabling the mixture fluid to rapidly flow in the microfluidic channel for diafiltration.

Both the effect of a centrifugal force and the flowing of a mixture fluid that undergoes diafiltration in a microfluidic channel are directional. Therefore, to ensure that a centrifugal force acts in a correct direction of pushing the mixture fluid to flow for diafiltration, the diafiltration assembly further includes a basement positioned in the container and used for arranging the microfluidic channel, so that the microfluidic channel is positioned by using the basement and the container, thereby ensuring that the centrifugal force acts in the correct direction of enabling the mixture fluid to flow for diafiltration.

The container has a first receiving chamber and a second receiving chamber that are not connected to each other, the first receiving chamber receives the mixture fluid that waits for diafiltration by the diafiltration assembly, and the second receiving chamber receives mitochondria obtained after diafiltration by the diafiltration assembly. Accordingly, the diafiltration assembly should be located between the first receiving chamber and the second receiving chamber, so that the first receiving chamber and the second receiving chamber can be connected only via the microfluidic channel.

When the first receiving chamber, the basement, and the second receiving chamber are sequentially arranged in an axial direction parallel to the moving axis, the basement has a plate form, and the microfluidic channel forms a flow inlet for entry of the mixture fluid on one side of the basement and forms a flow outlet for discharge of mitochondria obtained after diafiltration on the other side of the basement. The flow inlet of the microfluidic channel may be directly or indirectly connected to the first receiving chamber, and the flow outlet of the microfluidic channel is also directly or indirectly connected to the second receiving chamber.

The flow inlet of the microfluidic channel may be indirectly connected to the first receiving chamber via a flow inlet space, and the flow outlet of the microfluidic channel may be indirectly connected to the second receiving chamber via a flow outlet space.

To form the flow inlet space, the basement may have a first plate and a second plate stacked with each other and a hole penetrating the first plate, a hole opening at an end of the hole is closed by the second plate, and the hole forms a part of the flow inlet space.

The microfluidic channel is located between the first plate and the second plate, and the flow inlet of the microfluidic channel is connected to the flow inlet space.

The flow outlet space is disposed between the first plate and the second plate and extends to an outside end, away from the hole, of the basement. Furthermore, the outer diameter of the second plate may further be less than the outer diameter of the first plate, so that an open space between a circumferential side of the second plate and a side plate surface of the first plate forms a part of the flow outlet space.

To facilitate use and save users the trouble of aligning an effect direction of a centrifugal force with a flowing direction of the mixture fluid for diafiltration, a plurality of microfluidic channels are provided in the diafiltration assembly, and are distributed on the basement radially with a hole axis of the hole provided on the first plate being the center.

The container further includes a fixing space used for accommodating the diafiltration assembly, so that the diafiltration assembly is positioned in the container.

To provide the fixing space, the container may have a tube member that is open at two ends of a tube axis, a first baffle bar and a second baffle bar separated from each other are distributed in the tube member, and the fixing space is located between the first baffle bar and the second baffle bar.

The tube member has a tube body and an end ring, the end ring is fixedly disposed at an end of the tube axis of the tube body, and the first baffle bar and the second baffle bar are distributed on the tube body and the end ring.

### BRIEF DESCRIPTION OF THE DRAWINGS

FIG. 1 is an exploded view according to a preferred embodiment of the present invention.

FIG. 2 is an assembled view according to a preferred embodiment of the present invention.

FIG. 3 is a sectional view along a section line 3-3a in FIG. 2 according to a preferred embodiment of the present invention.

FIG. 4 is a partial enlarged view of an area A in FIG. 3 according to a preferred embodiment of the present invention.

FIG. 5 is a planar view of microfluidic channels according to a preferred embodiment of the present invention.

FIG. 6 is a partial enlarged view of an area B in FIG. 5 according to a preferred embodiment of the present invention.

### DETAILED DESCRIPTION OF THE PREFERRED EMBODIMENTS

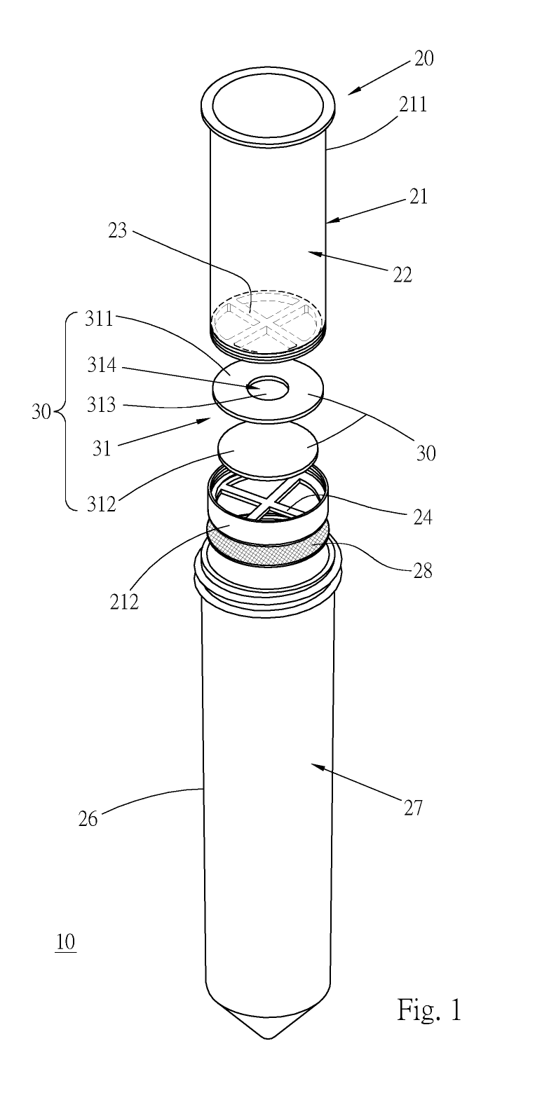

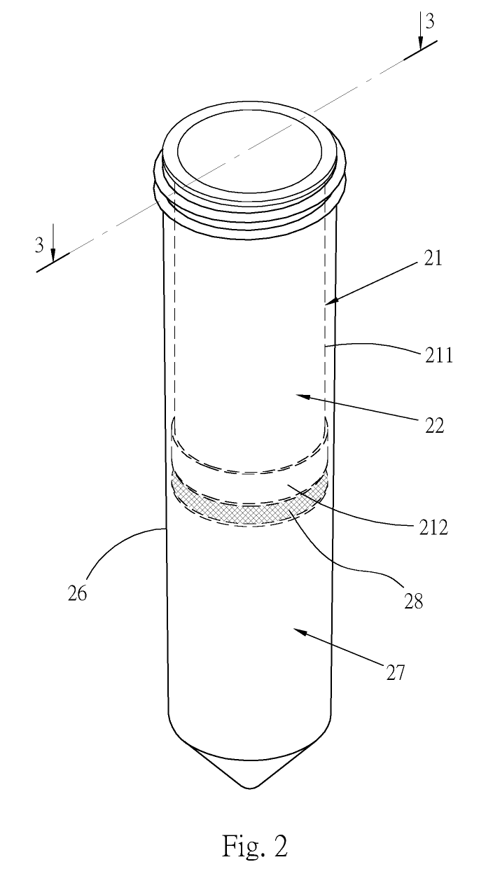

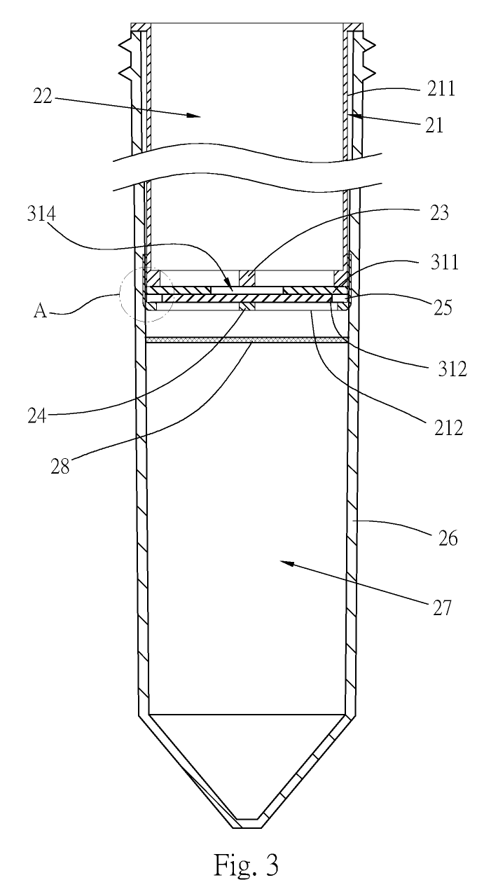

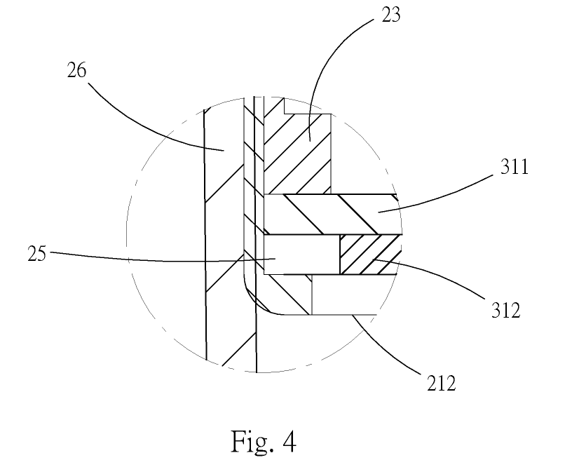

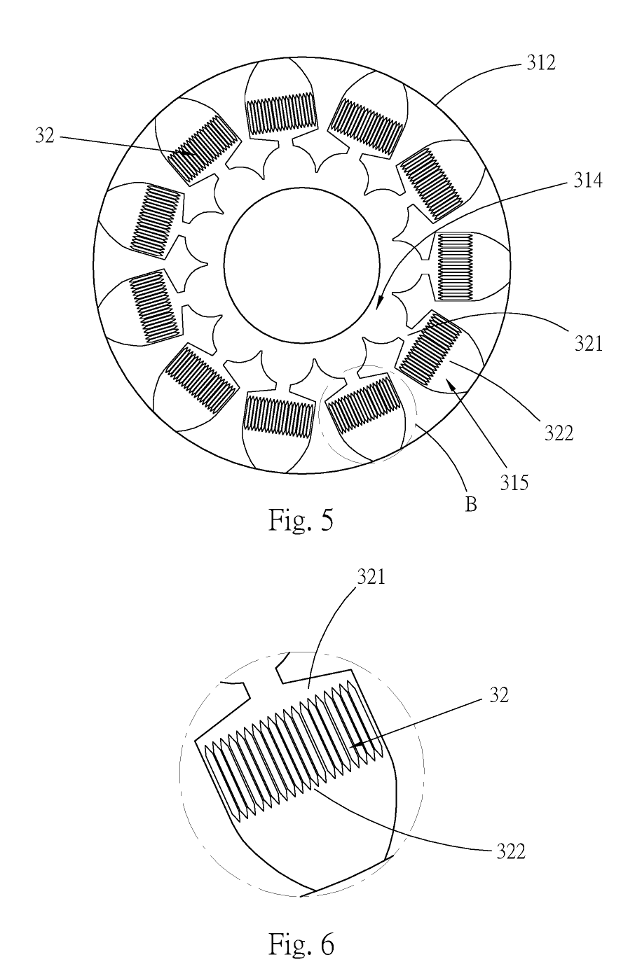

Referring to FIG. 1 to FIG. 5, a mitochondria extraction apparatus (10) provided in a preferred embodiment of the present invention makes a circular motion about a moving axis under an external force, and mainly includes a container (20) and a diafiltration assembly (30).

The container (20) has a tubular tube member (21) that is open at two ends of a tube axis. A first receiving chamber (22) is defined by a space in a hollow tube of the tube member (21). Two first baffle bars (23) and two second baffle bars (24) that respectively intersect in a cross form are distributed separately from each other on a tube wall at an end of the tube axis of the tube member (21), and are respectively perpendicular to the tube axis of the tube member (21). A fixing space (25) is located between the first baffle bars (23) and the second baffle bars (24), and is connected to the first receiving chamber (22). A generally cylindrical hollow sleeve member (26) is coaxially sleeved over the tube member (21). A second receiving chamber (27) is defined by the hollow inside of the sleeve member (26). The tube member (21) is located in the second receiving chamber (27), and the first receiving chamber (22) and the second receiving chamber (27) are not directly connected to each other. A filter (28) is fixedly disposed in the second receiving chamber (27), and is located between the tube member (21) and the cylindrical bottom the sleeve member (26).

Specifically, the tube member (21) has a tube body (211) and an end ring (212) coaxially threaded to an end of the tube axis of the tube body (211), and the first baffle bars (23) and the second baffle bars (24) are distributed at the end of the tube axis of the tube body (211) and the end ring (212).

The diafiltration assembly (30) is accommodated in the fixing space (25) and combined with the tube member (21), and structurally has a circular plate-form basement (31) inserted in the fixing space (25) with the center being coaxial with the tube axis of the tube member (21), so as to block the connection between the first receiving chamber (22) and the second receiving chamber (27). A plurality of hole-shaped microfluidic channels (32) are distributed on the basement (31), and the first receiving chamber (22) and the second receiving chamber (27) are connected via the microfluidic channels (32).

Furthermore, the basement (31) has a circular first plate (311) and a circular second plate (312) that are coaxially stacked with each other. A hole (313) penetrates through the center of the first plate (311), and a hole opening at an end is closed by the second plate (312), so that a hole space of the hole (313) defines a flow inlet space (314). The outer diameter of the second plate (312) is less than the outer diameter of the first plate (311), so that an annular flow outlet space (315) is defined between a circumferential side of the second plate (312) and a side plate surface of the first plate (311). The flow inlet space (314) is connected to the first receiving chamber (22), and the flow outlet space (315) is connected to the second receiving chamber (27).

The microfluidic channels (32) are distributed between the first plate (311) and the second plate (312) radially with a hole axis of the hole (313) being the center, and are respectively connected to the flow inlet space (314) through a flow inlet hole opening (321) and connected to the flow outlet space (315) through flow outlet hole openings (322).

In this way, the mitochondria extraction apparatus (10) receives a mitochondria-containing mixture fluid by using the first receiving chamber (22), and enabling the mitochondria-containing mixture fluid to enter the microfluidic channels (32) via the flow inlet space (314) and the connected flow inlet hole opening (321). After the mitochondria-containing mixture fluid flows in the microfluidic channels (32) and diafiltration is performed, mitochondria obtained after diafiltration flow out respectively through the flow outlet hole openings (322) of the microfluidic channels (32) and flow into the second receiving chamber (27) through the flow outlet space (315), and may be filtered by the filter (28) in the second receiving chamber (27), to achieve a mitochondria extraction effect.

Moreover, when the mitochondria extraction apparatus (10) makes a circular motion, an effect direction of a centrifugal force in the mitochondria extraction apparatus (10) is close to a flowing direction in which the mixture fluid flows in the microfluidic channels (32) for diafiltration, that is, is correspondingly the same as a direction from the flow inlet hole opening (321) to the flow outlet hole openings (322) of the microfluidic channels (32), so that the centrifugal force pushes the mixture fluid to flow in the microfluidic channels (32), to achieve better extraction efficacy.

Moreover, the following content should be further described:

First, when the mitochondria extraction apparatus (10) makes a circular motion, the mixture fluid in the flow inlet space (314) moves in a centrifugal direction and can only enter a microfluidic channel located on a centrifugal side, and a microfluidic channel on a centripetal side naturally does not achieve a mitochondria extraction effect with no mixture fluid entering. However, the microfluidic channels (32) are radially disposed, so that during the use of the mitochondria extraction apparatus (10), the direction of a centrifugal force does not need to be aligned with the flowing direction of the mixture fluid for diafiltration. Some microfluidic channels are always located on a centrifugal side to implement mitochondria extraction.

Second, the end ring (212) is threaded to the tube body (211) to facilitate the positioning and replacement of the diafiltration assembly (30), thereby achieving convenient use.

Third, the mixture fluid and extracted mitochondria are located in different receiving chambers. Therefore, after an extraction procedure is completed, the diafiltration assembly (30) can be separated from the sleeve member (26) at the same time when the tube member (21) is directly removed, so that only the extracted mitochondria are left in the second receiving chamber (27), thereby further achieving convenient use.

Four, the microfluidic channels (32) may form grooves on a side plate surface, facing the first plate (311), of the second plate (312) by using a manufacturing method of chemical etching or molding, and the first plate (311) and the second plate (312) are stacked with each other to close openings of the grooves, thereby defining the microfluidic channels.

In addition, the flow outlet space is not limited to the foregoing embodiments, and may alternatively be disposed between the first plate and the second plate and extend to a side of a basement, thereby connecting flow outlet hole openings of the microfluidic channels and a space outside the basement. The first plate and the second plate are plate-form bodies having the same outer diameter.

What is claimed is:

1. A mitochondria extraction apparatus, making a circular motion with a moving axis being the center under the effect of an external force, comprising:
a container, having a first receiving chamber used for receiving an external mitochondria-containing mixture fluid to be separated, and a second receiving chamber and the first receiving chamber being separated from each other;
a diafiltration assembly, having a basement, located between the first receiving chamber and the second receiving chamber, at least one hole-shaped microfluidic channel being disposed in the basement in a manner of extending in a direction perpendicular to the moving axis, a flow inlet hole opening at one end being connected to the first receiving chamber, a flow outlet hole opening at the other end being connected to the second receiving chamber, and the flow inlet hole opening being located between the flow outlet hole opening and the moving axis, wherein
after the mitochondria-containing mixture fluid to be separated enters the microfluidic channel from the first receiving chamber via the flow inlet hole opening and diafiltration is performed, mitochondria flow out from the flow outlet hole opening and flow into the second receiving chamber, and when the mitochondria extraction apparatus makes a circular motion, the mitochondria-containing mixture fluid to be separated is subject to the effect of a centrifugal force in the microfluidic channel to be under a force of flowing in a direction of the flow outlet hole opening, thereby accelerating extraction of the mitochondria from the mitochondria-containing mixture fluid to be separated.

2. The mitochondria extraction apparatus according to claim 1, wherein the basement further comprises a first plate and a second plate stacked with each other, and the microfluidic channel is located between the first plate and the second plate.

3. The mitochondria extraction apparatus according to claim 2, wherein the microfluidic channel is concavely provided on a side plate surface, facing the first plate, of the second plate, and a concave opening facing the second plate is closed by the second plate.

4. The mitochondria extraction apparatus according to claim 2, wherein the diafiltration assembly further comprises a flow inlet space connecting the first receiving chamber and the flow inlet hole opening.

5. The mitochondria extraction apparatus according to claim 4, wherein the first plate has a first plate body, a hole penetrates the first plate body, and a hole opening at an end is closed by the second plate, so that a hole space of the hole forms the flow inlet space.

6. The mitochondria extraction apparatus according to claim 5, wherein the hole is coaxial with the geometric center of the first plate body.

7. The mitochondria extraction apparatus according to claim 6, wherein a plurality of microfluidic channels are provided, and are distributed on the basement radially with a hole axis of the hole being the center.

8. The mitochondria extraction apparatus according to claim 2, wherein the diafiltration assembly further comprises a flow outlet space connecting the second receiving chamber and the flow outlet hole opening.

9. The mitochondria extraction apparatus according to claim 8, wherein the flow outlet space is located between the first plate and the second plate, and extends from the flow outlet hole opening to an outer side of the basement.

10. The mitochondria extraction apparatus according to claim 9, wherein the outer diameter of the second plate is less than the outer diameter of the first plate, and an open space between a circumferential side of the second plate and a side plate surface of the first plate becomes a part of the flow outlet space.

11. The mitochondria extraction apparatus according to claim 1, wherein the container comprises a fixing space connected to the first receiving chamber and used for accommodating the diafiltration assembly.

12. The mitochondria extraction apparatus according to claim 11, wherein the container has a tube member being open at two ends of a tube axis, a first baffle bar and a second baffle bar are distributed in the tube member in a manner of being separated from each other and extend in a direction perpendicular to the tube axis of the tube member, and the fixing space is located between the first baffle bar and the second baffle bar.

13. The mitochondria extraction apparatus according to claim 12, wherein the tube member has a tube body and an end ring, the end ring is fixedly disposed on an end of the tube axis of the tube body, and the first baffle bar and the second baffle bar are distributed on the tube body and the end ring.

14. The mitochondria extraction apparatus according to claim 13, wherein the end ring is coaxially threaded to an end of the tube axis of the tube body.

15. The mitochondria extraction apparatus according to claim 12, wherein the container further comprises a sleeve member, the second receiving chamber is disposed in the sleeve member, and the tube member is received in the second receiving chamber.
